(19) United States
(12) Patent Application Publication
(10) Pub. No.: US 2004/0020870 A1
(43) Pub. Date: Feb. 5, 2004

(54) Method of filter backwashing: extended terminal subfluidization wash

(76) Inventor: James Emanuel Amburgey JR., Lawrenceville, GA (US)

Correspondence Address: Dr. James E. Amburgey, 2291 Plantation Court, Lawrenceville, GA, 30044, US

(21) Appl. No.: 10/631,273

(22) Filed: Jul. 31, 2003

Related U.S. Application Data
(60) Provisional application No. 60/399,977, filed on Jul. 31, 2002.

(51) Int. Cl. C02F 1/00

(52) U.S. Cl. 210/793

(57) ABSTRACT

Porous media filters are commonly cleaned by backwashing. Immediately following the backwashing process, a high concentration of contaminant(s) pass through the filter, which is a phenomenon know as filter “ripening” or maturation in the municipal water treatment community. A new process has been invented that can reduce the concentration of contaminants that pass through a filter during “ripening” and is called the extended terminal subfluidization wash (ETSW). ETSW is a new backwashing process for porous media filters that involves using a washwater flow rate below the minimum fluidization velocity of at least some of the filter media grains following the primary cleaning stage of backwashing (e.g., fluidization) for an amount of time sufficient to displace the majority of the water volume in the filter during the overflow portion of the backwashing process.

### CROSS-REFERENCE TO RELATED APPLICATIONS

This application claims priority to the provisional patent application No. 60/399,977, filed Jul. 31, 2002, entitled EXTENDED TERMINAL SUBFLUIDIZATION WASH

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention pertains to the purification of municipal or industrial water and wastewater streams and potentially to other types of liquid streams from which dissolved or suspended contaminant removal can be accomplished by filtration through a volume of porous material(s). After a period of filtration, the pores of the filter material(s) begin to accumulate impurities that can impede further operation of the filter. When cleaning of a filter is deemed necessary, a process known as backwashing is typically employed whereby water (and sometimes air) is forced upward through a porous media filter. The upward flow of water through a filter can cause the media to fluidize, or become suspended in the fluid flow, when sufficiently high flow rates are employed. At least partial fluidization of a bed of media is commonly achieved during backwashing. Following the backwashing process, a high concentration of contaminants may pass through the filter immediately following restart, which is a phenomenon know as filter “ripening” or maturation.

Filter “ripening” is a well-known problem in municipal drinking water treatment. The “ripening” period has been documented in the literature for more than 100 years, and detailed studies of the mechanisms involved in the process date back more than 20 years (Pittsburg Filtration Commission, 1899; Amirtharajah and Wetstein, 1980). Some studies have shown that more than 90% of particles passing through a well-operated filter do so during the “ripening” period (Amirtharajah, 1988). The filter “ripening” process is still not fully understood, and the increased passage of particles into the finished water supply is not typically well managed.

The current understanding of filter “ripening” or the filter “ripening” sequence (FRS) as expounded by Cranston and Amirtharajah (1987) and Amirtharajah and Wetstein (1980) is as follows. The FRS can be divided into five distinct stages. The lag phase comes first and is due to the clean water remaining in the underdrain region of the filter at the conclusion of the backwash procedure. The next stage is the media disturbance and intramedia remnant stage, which is largely associated with the particles dislodged from the media and remaining in the pore water (and possibly particles detached by media grains colliding with each other as the bed settles following fluidization). The third stage is the upper filter remnant stage and is due to backwash remnant particles (dislodged particles not removed from the filter) remaining in the filter box above the media at the completion of the backwash procedure. The fourth stage is the influent mixing and particle stabilization stage. Once the filter influent valve is opened, filter influent water enters the filter and mixes with the backwash remnant water in the upper region of the filter box. The division between the third and fourth stage is somewhat indistinct due to the degree of intermixing. The fifth and final stage of the FRS is the dispersed remnant and filter media conditioning stage where newly attached particles become collectors of other particles within the filter and improve filtration performance. In the absence of backwash remnants and additional collectors, for example in a model system with pre-cleaned spherical glass beads as filter media, filter “ripening” may consist only of the fifth stage. However, in real-life situations with continuously operated filters, the media is typically already coated with a significant number of particles (or additional collectors) and the fifth stage may be almost unnoticeable. After completion of a backwash, an immediate analysis of the media within a filter will provide evidence of the additional collectors remaining on the filter media following a backwash. Wolfe and Pizzi (1999) describe a method called “floc retention analysis” of filter media by coring, which verifies the presence of particles on the filter media immediately following a backwash procedure. In summary, the presence of backwash remnant particles (i.e., particles detached during backwashing that are not removed from the filter) is typically the dominant cause of the filter “ripening” phenomenon in real-world filters.

Increasingly stringent federal water quality regulations and the threat of waterborne Cryptosporidium outbreaks has led to several strategies being investigated in recent years for reducing the impact of filter “ripening” on filtered water quality. Filter-to-waste is a common procedure where filter effluent water is diverted away from the finished water supply until the quality of the water reaches the desired quality. Although wasteful, filter-to-waste can effectively eliminate much of the impact of filter “ripening” of filtered water quality if adequate time (up to several hours in some cases) is allowed for the turbidity to reach the desired goals (Bucklin et al, 1988; Cleasby et al, 1989). However, not all treatment plants are designed with this facility. Furthermore, the opening and closing of valves results in changing filtration rates that may cause additional spikes in effluent turbidity immediately following redirection of filtered water into the finished water supply (Bucklin et al, 1988). While wasteful and not totally effective in eliminating increased particle passage into the filtered water supply, filter-to-waste is a commonly used means of alleviating much of the impact of filter “ripening” on drinking water quality. Filter-to-waste typically requires its own system of pipes and valves to divert contaminated water away from the finished water supply until the quality reaches the desired level. In U.S. Pat. No. 5,137,644, issued to Brian G. Stone on Aug. 11, 1992, an innovative approach of using the backwash water pipes for the dual purpose of backwashing and filter-to-waste was devised, but there is still the requirement of additional valves to divert the water in the proper direction, the cost of pipes running to the flow equalization tanks, the cost of adequately sizing the equalization tanks to handle the filter-to-waste flow, and the expense of pumping the water back to the head of the plant to be treated again. So, filter-to-waste is far from an ideal solution to the filter “ripening” problem.

Procedures involving coagulant addition to a filter during or immediately after backwashing have also been employed. Polymer and/or metal-based coagulants can be added directly to a portion of the backwash water supply during backwashing (Cleasby et al, 1992; Cranston and Amirtharajah, 1987; Francois and Van Haute, 1985; Yapijakis, 1982; Harris, 1970). This procedure is effective in reducing filter “ripening” particle passage, but it also presents some challenges. First, the addition of coagulants to the backwash water can lead to floc formation in filter underdrains and clearwells with carryover into the distribution system. Next, the logistics of supplying an accurate amount of chemical during a brief window of time to every filter during backwashing can be difficult. Finally, changes in influent water quality parameters may necessitate changes in coagulant dose, and a pilot plant may be required to determine optimum doses on a continual basis. Adding coagulants to the settled water as it refills the filter after backwashing is a similar technique that shares many of the same disadvantages as adding coagulants to the backwash water. The technique of adding coagulants during or immediately following backwashing has seen only limited use in water treatment facilities through the years.

Accordingly, there remains a need for a simple, cost-efficient, and effective means of reducing the passage of contaminants through a filter during the filter “ripening” period. An ideal backwash process would be easy-to-use, able to be incorporated into existing facilities without great expense, could potentially reduce the level of washwater use below the existing level, and would effectively prevent the passage of high concentrations of particles, pathogens, and potentially other contaminants from entering the finished water supply.

### BRIEF SUMMARY OF THE INVENTION

A new process for controlling the amount of contaminant passage into the filtrate during the “ripening” period of a filter run has been invented. The new process is called extended terminal subfluidization wash (ETSW). ETSW is a new way of backwashing a porous filter so as to minimize the passage of contaminants following the return of the filter to normal operation. ETSW involves using a washwater flow rate below the minimum fluidization velocity of at least a portion of the filter media grains following the primary cleaning stage of backwashing (e.g., fluidization) for an amount of time sufficient to displace the majority of the water volume present within the filter during the overflow portion of the backwashing process. ETSW typically reduces the amount of contaminants that pass into the filter effluent stream after a backwash, and ETSW may also reduce the volume of water required to complete the backwashing process depending on how it is assimilated with other backwashing processes.

### BRIEF DESCRIPTION OF THE SEVERAL VIEWS OF THE DRAWING

Not Applicable

### DETAILED DESCRIPTION OF THE INVENTION

The acronym ETSW provides a good description of the extended terminal subfluidization wash backwash process. ETSW must be extended for a period of time sufficient to displace the majority of the water remaining in the filter during the overflow portion of the backwash. ETSW must be a terminal process that comes at the end of the backwashing routine, and ETSW must use washwater flow rates that are below the minimum fluidization velocity of at least a portion of the filter media grains (i.e., subfluidization). ETSW is a functional wash technique that effectively removes particles from the filter instead of merely being a transitory step in stopping the flow of washwater following fluidization. The intent of ETSW is to remove the backwash remnant particles that are normally left within the media and above it following fluidized bed backwashing and consequently preventing their passage into the finished water supply. In short, the lower flow rates associated with the ETSW procedure produce smaller shear forces at the media surfaces and cause fewer additional particles to be removed from the media while the particles already detached during fluidization (potential backwash remnant particles) are transported out of the filter. Previous research (Amirtharajah, 1985) has shown that the highest backwash remnant particle concentration occurs at the level of the backwash troughs because that water passed through the filter media while it possessed the highest concentration of solids. Once the filter is restarted, the passage of the highest concentrations of filter effluent particles is generally associated with the highest concentration of backwash remnant particles (i.e., with the water present at the level of the backwash trough at the conclusion of the backwash cycle), but the load of backwash remnant particles can be significantly reduced by the ETSW procedure.

The act of leaving a newly washed filter with the lowest possible concentration of solids in the initial volume of water may seem counterintuitive if you subscribe to the theory that filter “ripening” is primarily the result of the lack of additional collectors. A higher concentration of backwash remnant particles would theoretically increase the number of additional collectors more rapidly and produce higher quality effluent water in a shorter period of time. The results of a previous study indicate that the backwash remnant particles are the primary cause of the filter “ripening” particle passage and leaving more remnant particles in the filter box increases the magnitude of the aforementioned particle passage (Amburgey, 2002).

The key to understanding the negative impact of backwash remnant particles on filter “ripening” appears to be changes in the remnant particle surface charge relative to the original surface charge of the particles upon entering the filter. The zeta potential of the backwash remnant particles become increasingly negative as the backwash procedure progresses (Amburgey, 2002). The negative surface charge of the particles will repel the negative surface charge of the filter media thereby decreasing the efficiency of the filter to remove the negatively charged particles relative to newly influent (destabilized) particles.

ETSW is intended for removing backwash remnant particles from the filter (both within and above the media) after a fluidized bed backwash while minimizing the production of further remnant particles. The result is fewer electrically stable remnant particles passing through the bed during the FRS. The overall passage of contaminants through the filter is decreased due to the reduction in number of stabilized remnant particles produced during backwashing and left in the filter prior to restart. The front end of the peak corresponding to particles produced during fluidized backwashing is gradually eliminated with each increment of the ETSW duration as these remnant particles are flushed out of the filter (beginning at the bottom of the filter and progressing upward). Each increase of the ETSW duration shifts the peaks of the FRS turbidity curves later into the filter run by depleting the number of intramedia remnant particles left in the lower parts of the filter at the end of backwash.

The ETSW procedure is intended to reduce the eventual passage of particles during the “ripening” period and not at optimizing the cleaning efficiency of the backwash procedure. Thus, adequate cleaning of the filter media is required prior to initiation of the ETSW portion of the complete backwash regimen. With vigorous backwash procedures like air scour, only a brief duration of fluidization might be necessary prior to starting the ETSW and significant reductions in washwater usage may be realized. However, if fluidization alone is the sole means of cleaning the filter media, then shortening the fluidization portion of the backwash procedure may or may not be practical. The ETSW step could simply be added at the end of a full-length fluidization step. ETSW does allow better control of the backwash cycle such that after the desired (or sufficient) amount of solids has been removed from the media grains, the ETSW procedure can simply carry the solids out of the filter box without need for any additional duration of fluidization to finish the wash cycle. While decreasing washwater usage may or may not be realized by a given facility, the primary benefit of ETSW is improving the quality of the water produced by the filter immediately following restart. The improved water quality might allow shortening or even elimination of the filter-to-waste procedure, and the ETSW procedure is even more important to facilities not designed to accommodate the filter-to-waste practice.

While the amount of benefit from ETSW may vary between facilities and their respective operational practices, it appears that most facilities would see some benefit from ETSW. The cost of ETSW is minimal to none. ETSW may require an increased duration of the backwash cycle since the lower ETSW rates require more time move water through the filter box and in some cases a slight increase in washwater use. However, the benefits of decreased pathogen passage, reduced filtered water turbidity, decreased filter-to-waste volumes, and often decreased volumes of filter backwash water to treat and recycle are likely to offset any costs incurred.

Implementation of the ETSW procedure requires the selection of an effective subfluidization wash rate and an appropriate duration at the selected washwater flow rate. The subfluidization wash rate must be selected from a range of values below the minimum fluidization velocity of at least a portion of the filter media. Since most porous media filters contain a distribution of grain sizes and quite often types of media, it is recommended to begin by calculating the minimum fluidization velocity of each type of media for the sizes above and below which approximately 10% (by weight) of the media grains fall. Cleasby (1990) described a set of equations that can be used to calculate the minimum fluidization velocity for a uniform sized media. When calculating the minimum fluidization velocity of a particular size and type of media, it is important to take into account the changes in density and viscosity of water that occur due to changes in the backwash water temperature, which may vary seasonally. Amirtharajah et al. (1991) described an equation that can be used to calculate the minimum fluidization velocity for a dual media filter.

The aforementioned equations can generally be used to establish some upper and lower flow rate limits for ETSW at the water temperatures encountered by a given treatment facility. As a general rule of thumb, it is generally best to start with lowest ETSW rate calculated and work up from there by experimentation to find the optimum ETSW rate for a given application.

Calculating the pore volume of the media and the volume of the filter box between the media surface and the top of washwater troughs will facilitate calculation of a reasonable ETSW duration via division of that volume by the ETSW rate used. A scaling factor may need to be applied to the ETSW duration to account for dispersion and/or the uneven distribution of washwater within a filter. Once an ETSW rate and duration combination are selected, some experiments may be necessary to find the best rates and times for a given set of operational goals. If the FRS turbidity spike remains unchanged or too high, then a lower ETSW rate is recommended. If the turbidity spike is effectively eliminated then a higher ETSW rate may be used to decrease the amount of time required to backwash a filter. Changes in water temperature and optimality of the coagulation process may significantly impact the effectiveness of ETSW procedure and may require appropriate action. Floc characteristics (e.g., strength) are thought to play a role in how effectively a particular ETSW rate performs, which might cause much different ETSW rate selections at facilities with identical filter media designs. After finding a suitable ETSW rate and duration, a decision must be made on exactly how to best blend the ETSW into the whole backwash procedure. As mentioned previously, shortening the duration of the fluidization step might allow some cost savings, but some caution must be exercised to avoid problems associated with inadequate cleaning of the filter media.

There are multiple existing approaches to backwashing granular media filters, which include: upflow wash with full fluidization, surface wash plus fluidized bed backwash, air-scour alone before fluidized bed backwash, and simultaneous air scour and water backwash followed by fluidization (Cleasby and Logsdon, 1999). Regardless of how the aforementioned backwash procedures begin, they all end with fluidization of the filter media. Backwash guidelines sometimes recommend a slow decline or several distinct downward steps in backwash flow rates at the end of the backwash procedure. However, the preceding backwash strategies are aimed at optimal restratification of the media or softening media collisions during collapse from a fluidized to a fixed bed (Cleasby and Logsdon, 1999; Amirtharajah, 1985) and were not intended for reducing contaminant passage through the filter during filter “ripening.” Thus, the act of gradually terminating a backwash procedure by the previously mentioned technique typically last about 1 to 2 minutes and only remove a minor portion of the backwash remnant particles (and consequently have only a minor impact of filter “ripening” particle passage). ETSW is a distinct wash procedure that would be practiced after the fluidization step of an existing backwash procedure to control the filter “ripening” water quality. The intent, flow rate restrictions, and duration of ETSW differ substantially from those associated with gradually terminating a backwash procedure. ETSW is restricted to subfluidization flow rates, but gradual backwash termination could include lower flow rates that continue to fluidize the filter bed. The duration of ETSW must be sufficient to displace the majority of the backwash remnant particles from the filter thereby preventing their return through the filter. The practice of ETSW will often allow the fluidization step of the backwash process to be shortened (because the ETSW step is intended to remove detached solids from filter) thereby decreasing the total use of washwater. ETSW is not merely a gentle means of changing from a fluidized bed to a fixed bed at the end of the backwash cycle.

Ives and Fitzpatrick (1989) used high-speed video recording to observe kaolinite particle detachment from sand grains during subfluidization filter backwashing. As the backwash flow was increased (still at subfluidization velocities), there was an apparently instantaneous detachment of the unstable deposits. Under subfluidization rates, particles in crevices or apparent dead spaces in pores were not removed. Subfluidization backwashing is a rather weak and ineffective means of removing solids from a filter bed and is not recommended as a backwash procedure by itself. Rather, subfluidized backwashing should be performed after the fluidized backwash has removed the majority of the particles from the filter bed. Subfluidized backwashing can still effectively remove detached particles from the filter without detaching additional particles to take their place, as would tend to be the case with a continued fluidization wash. Following a fluidized bed backwash with a subfluidized bed backwash is precisely the intent of the ETSW process.

The use of a two-stage backwashing process is not a novel idea. U.S. Pat. No. 4,187,175 was issued to Roberts et al. on Feb. 5, 1980 for a control system to perform a two-stage backwash procedure. However, the idea of Roberts et al. (1980) was to first use a rate that barely fluidized the granular bed, and the second rate was an equal or even greater backwash rate (based on the temperature of the fluid). The first stage was intended to separate the particles from the granular media, and the second stage was intended to use an even greater wash rate to remove the detached particles from filter chamber. The two-stage procedure of Roberts et al. (1980) was intended to achieve more efficient removal of already detached solids while shortening the duration of the entire backwash procedure via the higher flow rates of the second stage wash. ETSW takes an opposite approach of using a lower second stage backwash rate (typically less than half on first stage wash rate) that will lengthen the duration of the backwash procedure. The higher second stage wash rate of Robertson et al. (1980) may more efficiently remove detached solids from the filter, but the higher shear forces associated fluidizing wash rate will continue to detach significant numbers of additional particles from the media grains as washwater passes through the filter bed. In contrast, the lower shear forces associated with the subfluidization flow rates of an ETSW will not detach nearly so many particles from the media grains. Newly detached particles may remain within the filter chamber and pass into the filter effluent stream during the ensuing filter “ripening” period.

Some treatment plants use a low-rate (subfluidization) wash for a short duration prior to moving into a high-rate (fluidization) backwash. Use of an initial low-rate wash is intended to reduce the potential for forming mudballs during the backwash procedure (Tillman, 1996). An initial low-rate wash is distinguished from ETSW by the fact that the subfluidization step comes after the fluidization stage with the ETSW process. It is plausible to have an initial low-rate wash before fluidization and an ETSW after fluidization.

### REFERENCES CITED

### U.S. Patent Documents

| | | | |
|---|---|---|---|
| 4187175 | February 1980 | Roberts, et al. | 210/793 |
| 5137644 | August 1992 | Stone | 210/791 |

### Other References

Amburgey, J. E., 2002. Improving Filtration for Removal of Cryptosporidium Oocysts and Particles From Drinking Water. Doctoral Dissertation. Georgia Institute of Technology, Atlanta, Ga.

Amirtharajah, A. and D. P. Wetstein. 1980. Initial Degradation of Effluent Quality During Filtration. Journ. AWWA, 72(9):518-524.

Amirtharajah, A. 1985. The Interface Between Filtration and Backwashing. Wat. Res., 19:5:581-588.

Amirtharajah, A. 1988. Some Theoretical and Conceptual Views of Filtration. Journ. AWWA, 80(12):36-46.

Amirtharajah, A., McNelly, N., Page, G., and McLeod, J. 1991. Optimum Backwash of Dual Media Filters and GAC Filter-Adsorbers with Air Scour. AWWA Research Foundation, Denver, Colo.

Bucklin, K., Amirtharajah, A., and K. O. Cranston. The Characteristics of Initial Effluent Quality and its Implications for the Filter to Waste Procedure. AWWA Research Foundation, Denver, Colo., 1988.

Cleasby, J. L. 1990. Filtration. In Water Quality and Treatment 4^{th} ed., Pontius, F. W., ed. McGraw-Hill Inc., New York. ISBN: 0070015406

Cleasby, J. L., Dharmarajah, A. H., Sindt, G. L., and E. R. Baumann. 1989. Design and Operation Guidelines for Optimization of the High-rate Filtration Process: Plant Survey Results. AWWA Research Foundation, Denver, Colo.

Cleasby, J. L., and G. S. Logsdon. 1999. Granular Bed and Precoat Filtration. In Water Quality and Treatment, 5^{th} ed. McGraw-Hill, New York. ISBN: 0070016593.

Cleasby, J. L., Sindt, G. L., Watson, D. A., and E. R. Baumann. 1992. Design and Operation Guidelines for Optimization of High-rate Filtration Process: Plant Demonstration Studies. AWWA Research Foundation, Denver, Colo., 1992

Cranston, K. O., and A. Amirtharajah. 1987. Improving the Initial Quality of a Dual-Media Filter by Coagulants in the Backwash. Journ. AWWA, 79:12:50-63.

Francois, R. J. & Van Haute, A. A., 1985. Backwashing and Conditioning of a Deep Bed Filter. Wat. Res., 19:11:1357.

Harris, W. L., 1970. High Rate Filter Efficiency. Jour. AWWA, 62:8:515.

Ives, K. J. and C. S. B. Fitzpatrick. 1989. Detachment of Deposits from Sand Grains. Colloids and Surfaces. 39:239-353.

Pittsburg Filtration Commission, 1899. Report of the Filtration Commission of the City of Pittsburg, 166-169.

Tillman, G. M. 1996. Basic Water Treatment: Troubleshooting and Problem Solving. Ann Arbor Press, Chelsea, Mich. ISBN: 1575040018.

Wolfe, T. A. & Pizzi, N. G., 1999. Optimizing Filter Performance. Journ. NEWWA, 113:1:6.

Yapijakis, C., 1982. Direct Filtration: Polymer in Backwash Serves Dual Purpose. Jour. AWWA, 74:5:426.

What is claimed is:

1. A process for backwashing a particulate bed filter comprising the acts of:
(a) performing a terminal backwash step at a subfluidization washwater flow rate(s) following the primary cleaning stage(s) of a backwash procedure;
(b) maintaining the subfluidization washwater flow rate(s) for a period of time sufficient to displace the majority of the water volume within the filter at the beginning of the said process;
(c) allowing the backwash step to remove significant portions of the contaminant(s) displaced by the primary cleaning stage(s) of the backwashing procedure that might otherwise return through the filter following restart.

2. The process of claim 1 wherein said a subfluidization washwater flow rate is less than minimum fluidization velocity of at least portion of the media in the filter.

3. The process of claim 1 wherein said significant portions include at least 50% of the total concentration of a contaminant(s).

4. The process of claim 1 wherein said primary cleaning stage(s) of the backwash procedure are drawn from among (1) fluidization, (2) surface washes, (3) air scouring, and (4) combined air and water wash of the media(s).

5. The process of claim 1 wherein said the contaminant(s) include microorganisms less than about 50 microns in size.

6. The process of claim 1 wherein said the contaminant(s) include nonliving particles less than about 100 microns in size.

7. The process of claim 1 wherein said the contaminant(s) include organic compounds less than 500,000 Daltons in size.

8. The process of claim 1 wherein said the contaminant(s) include viruses.

9. The process of claim 1 wherein said the contaminant(s) include protozoans.

10. The process of claim 1 wherein said the contaminant(s) include bacteria.

11. The process of claim 1 wherein said the filter material(s) include any or all of the following: sand, anthracite coal, granular activated carbon, garnet, plastic filter material(s), and ceramic filter material(s).

12. The process of claim 1 wherein the amount of water required for the backwashing procedure is reduced.

13. The process of claim 1 wherein the amount of water diverted away from the product water stream following restart of a backwashed filter is reduced.

14. The process of claim 1 wherein the amount of chemical(s) introduced into the backwash water or the filter immediately following backwashing is reduced, and the chemical(s) are chosen from among: aluminum sulfate, aluminum chloride, ferric sulfate, ferric chloride, chitosan, cationic polymer(s), anionic polymer(s), nonionic polymer(s), and chemicals containing a trivalent metal ion(s) (e.g., Fe(III) or Al(III)).
